(19) United States
(12) Patent Application Publication
(10) Pub. No.: US 2025/0309341 A1
(43) Pub. Date: Oct. 2, 2025

(54) SOLID-STATE BATTERY

(71) Applicant: HONDA MOTOR CO., LTD., Tokyo (JP)

(72) Inventors: Seiichiro ISHIKAWA, Saitama (JP); Tadashi MATSUSHITA, Saitama (JP); Terumi FURUTA, Saitama (JP); Yohei NOJI, Saitama (JP)

(21) Appl. No.: 19/063,334

(22) Filed: Feb. 26, 2025

(30) Foreign Application Priority Data
Mar. 30, 2024 (JP) 2024058323

(51) Int. Cl. H01M 10/0562; H01M 4/36; H01M 4/62; H01M 10/0525; H01M 50/533

(52) U.S. Cl. CPC H01M 10/0562; H01M 4/366; H01M 4/621; H01M 10/0525; H01M 50/533

(57) ABSTRACT

Provided is a solid-state battery including, in an order, a positive electrode current collector, a positive electrode material layer, a prescribed solid electrolyte layer, a negative electrode side solid electrolyte layer, and a negative electrode, and further including a positive electrode tab that protrudes from the positive electrode current collector, and a negative electrode tab that protrudes from the negative electrode. A positive electrode frame, as an insulator, is provided closer to the negative electrode than the positive electrode current collector. Below, an area inside of outer edges of the positive electrode frame is defined as “sF”, an area of the prescribed solid electrolyte layer is defined as “sEc”, an area of the negative electrode side solid electrolyte layer is defined as “sEn”, and an area of the negative electrode is defined as “sN”. The solid-state battery satisfies a relationship “sEc≥sF>sN≥sEn”.

This application is based on and claims the benefit of priority from Japanese Patent Application 2024-058323, filed on 30 Mar. 2024, the content of which is incorporated herein by reference.

### BACKGROUND OF THE INVENTION

### Field of the Invention

The present invention pertains to a solid-state battery that is mounted to a vehicle or the like.

### Related Art

In recent years, the spread of electric vehicles such as EVs and HEVs has proceeded from a perspective of, inter alia, reducing emission of carbon dioxide to thereby reduce adverse effects on the global environment. Secondary batteries that are mounted to electric vehicles or the like include solid-state batteries such as the following.

A solid-state battery is provided with a positive electrode current collector, and is also provided with, in an order going away from the positive electrode current collector toward each of both sides in a stacking direction, a positive electrode material layer, a solid electrolyte layer, and a negative electrode. A positive electrode frame, as an insulator, is provided on a negative electrode side of the positive electrode current collector so as to surround a periphery of the positive electrode material layer. The positive electrode current collector and the positive electrode material layers configure a positive electrode. In addition, the solid-state battery is provided with a positive electrode tab that protrudes from the positive electrode current collector, and negative electrode tabs that protrude from the negative electrodes.

This solid-state battery is accommodated in a state of being pressed inside in the stacking direction such that layers that are adjacent to each other in the stacking direction are in close contact with each other. Therefore, in a state where the solid-state battery is in use, the positive electrode is always pressed to the negative electrode side, and the negative electrode is always pressed to the positive electrode side.

Patent Document 1: Japanese Unexamined Patent Application, Publication No. 2023-148244

### SUMMARY OF THE INVENTION

The inventors paid attention to the presence of the following problems in such solid-state batteries.

When most of such solid-state batteries are charged, the volume of a negative electrode increases due to, inter alia, occlusion of lithium, and the volume of the negative electrode decreases due to, inter alia, the release of lithium when such solid-state batteries are discharged. Due to change of the volume of this negative electrode, there is a risk that a short-circuit will occur between a positive electrode side electrical conductor and a negative electrode side electrical conductor. Therefore, it is desirable to ensure that an insulation distance between the positive electrode side electrical conductor and the negative electrode side electrical conductor is as large as possible.

On the other hand, the following problem can occur in a case where the insulation distance between the positive electrode side electrical conductor and the negative electrode side electrical conductor is ensured by reducing the area of a positive electrode current collector and a positive electrode frame when viewed from a stacking direction and indenting edges of the positive electrode current collector and the positive electrode frame to be more inside than edges of a solid electrolyte.

In a state where the solid-state battery is in use, it is not possible to use the positive electrode frame to receive a load applied to an edge of the negative electrode and acting toward the positive electrode. Therefore, the load is more likely to escape to the edge of the negative electrode. As a result, it is possible for a problem, such as lithium or the like being more likely to greatly occluded at edges of the negative electrode, to occur when the solid-state battery is being charged.

The present invention is made in light of the situation described above, and an object of the present invention is to facilitate ensuring a large insulation distance between a positive electrode side electrical conductor and a negative electrode side electrical conductor while facilitating a positive electrode frame to receive a load applied to an edge of the negative electrode and acting toward the positive electrode.

The inventors accomplished the present invention by finding that it is possible to achieve the object described above if areas of layers that are included in a solid-state battery have a prescribed size relationship. The present invention is a solid-state battery according to the following (1) through (12).

A first aspect of the present invention is directed to a solid-state battery including, in an order going toward at least one way in a stacking direction, a positive electrode current collector, a positive electrode material layer, a prescribed solid electrolyte layer, a negative electrode side solid electrolyte layer, and a negative electrode, as well as a positive electrode tab that protrudes from the positive electrode current collector, and a negative electrode tab that protrudes from the negative electrode, in which
a positive electrode frame, as an insulator, is provided closer to the negative electrode than the positive electrode current collector so as to surround a periphery of the positive electrode material layer,
the volume of the negative electrode increases in accordance with charging and the volume of the negative electrode decreases in accordance with discharging, and
defining the area inside of outer edges of the positive electrode frame in a plan view seen from the stacking direction as “sF”, defining the area of the prescribed solid electrolyte layer in the plan view as “sEc”, defining the area of the negative electrode side solid electrolyte layer in the plan view as “sEn”, and defining the area of the negative electrode in the plan view as “sN”,
a relationship “sEc≥SF>SN≥sEn” is satisfied.

By virtue of the present configuration, because “sN≥sEn”, it becomes easier to transfer the negative electrode side solid electrolyte layer to the negative electrode, while employing a material including the negative electrode as a base.

Because “sF>sEn”, the surface of the negative electrode side solid electrolyte layer on the positive electrode frame side is more likely to be flat. Furthermore, because “sF>SN”, a portion where the positive electrode frame corresponds to edges of the negative electrode is more likely to be wider. As a result, a load applied to an edge of the negative electrode and acting toward the positive electrode can be easily received by the positive electrode frame.

Moreover, because “sEc≥sF”, edges of the prescribed solid electrolyte layer are more likely to protrude outward than edges of the positive electrode frame. Therefore, the prescribed solid electrolyte layer can ensure an insulation distance between the positive electrode side electrical conductor and the negative electrode side electrical conductor.

By virtue of the present configuration, it is possible to facilitate ensuring a large insulation distance between the positive electrode side electrical conductor and the negative electrode side electrical conductor while facilitating the positive electrode frame to receive a load applied to an edge of the negative electrode and acting toward the positive electrode.

According to a second aspect, the solid-state battery of the first aspect described above further includes an intermediate layer between the negative electrode side solid electrolyte layer and the negative electrode, in which
defining the area of the intermediate layer in the plan view as “sM”, and
a relationship “sN≥sM≥sEn” is satisfied.

By virtue of the present configuration, the intermediate layer serves a prescribed role, whereby it is possible to improve the performance of the solid-state battery. addition, because “sN≥sM”, it becomes easier to transfer the intermediate layer to the negative electrode, while employing the material including the negative electrode as a base. In addition, even in a case where the intermediate layer is included in the negative electrode side electrical conductor, because “sN≥sM”, it becomes easier to ensure the insulation distance between the intermediate layer and the positive electrode side electrical conductor. In addition, because “sM≥sEn”, it becomes easier to transfer the negative electrode side solid electrolyte layer to the intermediate layer, while employing a material including the intermediate layer as a base.

According to a third aspect, the solid-state battery of the first or second aspect described above further includes a positive electrode side solid electrolyte layer between the positive electrode material layer and the prescribed solid electrolyte layer, in which
defining the area of the positive electrode side solid electrolyte layer in the plan view as “sEp”,
a relationship “sEc≥sF≥sEp” is satisfied.

By virtue of the present configuration, because “sF≥sEp”, it becomes easier to transfer the positive electrode side solid electrolyte layer onto the positive electrode frame, while employing a material including the positive electrode frame as a base. In addition, because “sEc≥sEp”, it becomes easier to transfer the positive electrode side solid electrolyte layer onto the prescribed solid electrolyte layer.

According to a fourth aspect, in the solid-state battery of any one of the first through third aspects described above, a relationship “sEc>sF” is satisfied.

By virtue of the present configuration, the prescribed solid electrolyte layer protrudes outward more than the positive electrode frame, whereby it is possible to further improve insulation properties between the positive electrode side electrical conductor and the negative electrode side electrical conductor.

According to a fifth aspect, in the solid-state battery of any one of the first through fourth aspects described above, the prescribed solid electrolyte layer protrudes, in a direction of protrusion of the negative electrode tab, more than the positive electrode frame.

By virtue of the present configuration, the prescribed solid electrolyte layer can ensure the insulation distance between the negative electrode tab and the positive electrode current collector.

According to a sixth aspect, in the solid-state battery of any one of the first to fifth aspects described above, the prescribed solid electrolyte layer is thicker in the stacking direction than the negative electrode side solid electrolyte layer.

By virtue of the present configuration, the prescribed solid electrolyte layer, which has the largest area and is more likely to protrude outward, is made thicker in the stacking direction, whereby it is possible to make the prescribed solid electrolyte layer less susceptible to damage, even when subjected to a press load or the like.

According to a seventh aspect, in the solid-state battery of any one of the first through sixth aspects described above, the prescribed solid electrolyte layer includes a porous base material and a solid electrolyte that is filled in the base material.

By virtue of the present configuration, the prescribed solid electrolyte layer is caused to contain a base material, whereby it is possible to make the prescribed solid electrolyte layer less susceptible to damage, even when subjected to a press load or the like.

According to an eighth aspect, in the solid-state battery of any one of the first through seventh aspects described above, the prescribed solid electrolyte layer containing a binder, and
a binder content in the prescribed solid electrolyte layer differing to a binder content in the negative electrode side solid electrolyte layer.

By virtue of the present configuration, binder content in the prescribed solid electrolyte layer differs to binder content in the negative electrode side solid electrolyte layer, whereby it becomes easier to perform adjustment such that the strength of the prescribed solid electrolyte layer is higher. As a result, it is possible to make the prescribed solid electrolyte layer less susceptible to damage, even when subjected to a press load or the like.

According to a ninth aspect, in the solid-state battery of any one of the first through eighth aspects described above further includes a positive electrode tab insulator that protrudes from the positive electrode frame in a direction of protrusion of the positive electrode tab, in which
the positive electrode tab insulator protrudes, in the direction of protrusion of the positive electrode tab, more than the prescribed solid electrolyte layer.

By virtue of the present configuration, the positive electrode tab insulator can ensure a greater insulation distance between the positive electrode tab and the negative electrode.

According to a tenth aspect, the solid-state battery of any one of the first through ninth aspects described above further includes a positive electrode side solid electrolyte layer between the positive electrode material layer and the prescribed solid electrolyte layer, and
an intermediate layer between the negative electrode side solid electrolyte layer and the negative electrode, in which
defining the area of the positive electrode material layer Pm in the plan view as “sPm”,
defining the area of the positive electrode side solid electrolyte layer in the plan view as “sEp”, and
defining the area of the intermediate layer in the plan view as “sM”,
a relationship “sEc≥sF≥sEp≥sN≥sM≥sEn≥sPm” is satisfied.

By virtue of the present configuration, because “sF≥sEp”, it becomes easier to transfer the positive electrode side solid electrolyte layer onto the positive electrode frame and the positive electrode material layer, while employing a material including the positive electrode frame and the positive electrode material layer as a base. In addition, because “sN≥sM”, it becomes easier to transfer the intermediate layer to the negative electrode, while employing the material including the negative electrode as a base. In addition, because “sM≥sEn”, it becomes easier to transfer the negative electrode side solid electrolyte layer to the intermediate layer, while employing the material including the intermediate layer as a base. In addition, because “sEc≥sEp”, it becomes easier to transfer the positive electrode side solid electrolyte layer onto the prescribed solid electrolyte layer. In addition, because “sEc≥sEn”, it becomes easier to transfer the negative electrode side solid electrolyte layer onto the prescribed solid electrolyte layer.

According to an eleventh aspect, the solid-state battery of any one of the first through tenth aspects described above further includes a resin coating that covers ends in directions that are orthogonal to the stacking direction of a multilayer body that includes the positive electrode current collector, the positive electrode material layer, the positive electrode frame, the prescribed solid electrolyte layer, the negative electrode side solid electrolyte layer, and the negative electrode.

By virtue of the present configuration, it is possible to use the resin coating to further improve insulation properties between the positive electrode side electrical conductor and the negative electrode side electrical conductor. Further, because “sEc>sEn” in the first aspect cited in the present configuration, the resin coating can more easily enter into a region, which is outside the edge of the negative electrode side solid electrolyte layer and is between the prescribed solid electrolyte layer and the negative electrode tab.

According to a twelfth aspect, in the solid-state battery of any one of the first through eleventh aspects described above, the negative electrode is provided with a negative electrode current collector, and a negative electrode material layer that is provided closer to the positive electrode current collector than the negative electrode current collector and includes metallic lithium.

By virtue of the present configuration, the effects described above are achieved in such a solid-state battery.

By virtue of the configuration according to the first aspect as above, it is possible to facilitate ensuring a large insulation distance between the positive electrode side electrical conductor and the negative electrode side electrical conductor while facilitating the positive electrode frame to receive a load applied to an edge of the negative electrode and acting toward the positive electrode. Furthermore, by virtue of the configurations according to the second through twelfth aspects described above, which cite the first aspect, respective additional effects are achieved.

### BRIEF DESCRIPTION OF THE DRAWINGS

FIG. 1 is an exploded perspective view illustrating each layer of a solid-state battery according to a first embodiment;

FIG. 2 is a plan view illustrating the solid-state battery;

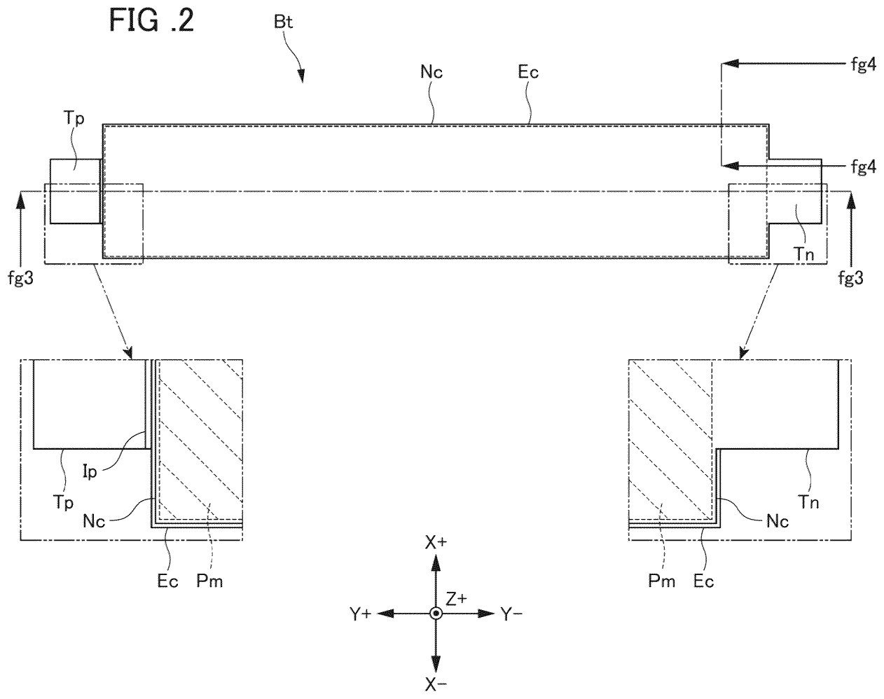

FIG. 3 is a cross-sectional view illustrating a cross-section along the fg3-fg3 line in FIG. 2;

FIG. 4 is a cross-sectional view illustrating a cross-section along the fg4-fg4 line in FIG. 2;

FIG. 5 is a cross-sectional view in which a solid-state battery according to a second embodiment is seen in an X direction; and

FIG. 6 is a cross-sectional view in which the solid-state battery is seen in a Y direction.

### DETAILED DESCRIPTION OF THE INVENTION

With reference to the drawings, description is given below regarding embodiments of the present invention. However, the present invention is not limited whatsoever to the following embodiments, and can be worked after being changed, as appropriate, within a range that does not deviate from the spirit of the present invention.

### First Embodiment

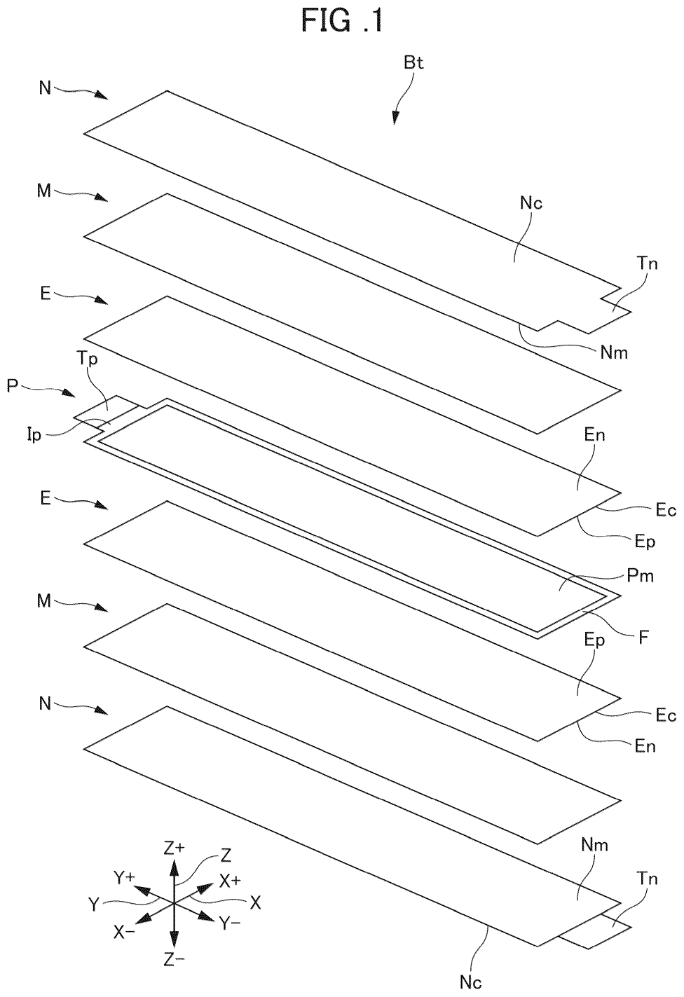

A solid-state battery Bt according to the present embodiment and illustrated in FIG. 1 is a lithium metal secondary battery and includes a plurality of layers. Three directions that are orthogonal to each other are referred to as an “X direction”, a “Y direction”, and a “Z direction” below. Note that the “Z direction” may be interpreted as a stacking direction. In addition, one side in the X direction is referred to below as the “X− side” and the opposite side is referred to as the “X+ side”. In addition, one side in the Y direction is referred to as “Y− side”, and the other side in the Y direction is referred to as the “Y+ side”. In addition, one side in the Z direction is referred to as the “Z− side”, and the opposite side is referred to as the “Z+ side”.

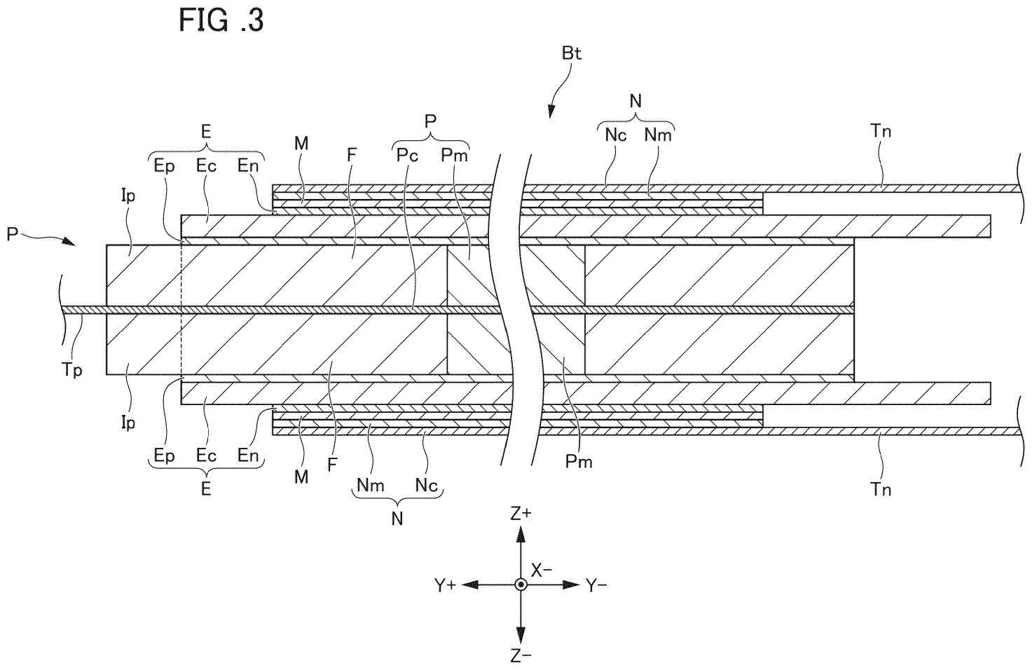

As illustrated in FIG. 3, the solid-state battery Bt includes a positive electrode current collector Pc and further includes, in an order going away from the positive electrode current collector Pc toward each of the Z+ side and the Z− side, a positive electrode material layer Pm, a positive electrode side electrolyte layer Ep, an intermediate electrolyte layer Ec, a negative electrode side electrolyte layer En, an intermediate layer M, a negative electrode material layer Nm, and a negative electrode current collector Nc. In addition, the solid-state battery Bt further includes, on each of the Z+ side and the Z− side with respect to the positive electrode current collector Pc, a positive electrode frame F, as an insulator, that surrounds the periphery of the positive electrode material layer Pm.

The positive electrode current collector Pc and the positive electrode material layers Pm configure a positive electrode P. Each group of a positive electrode side electrolyte layer Ep, an intermediate electrolyte layer Ec, and a negative electrode side electrolyte layer En configures a solid electrolyte layer E. Note that “positive electrode side electrolyte layer Ep” may be interpreted as a “positive electrode side solid electrolyte layer”, “intermediate electrolyte layer Ec” may be interpreted as a “prescribed solid electrolyte layer”, and “negative electrode side electrolyte layer En” may be interpreted as a “negative electrode side solid electrolyte layer”. Each group of a negative electrode material layer Nm and a negative electrode current collector Nc configures a negative electrode N.

A plan view seen from the Z direction is simply referred to as a “plan view” below. In addition, the area inside of the outer edge of the positive electrode frame F in the plan view is defined below as “sF”. The area of each positive electrode material layer Pm in the plan view is defined as “sPm”. The area of the positive electrode side electrolyte layer Ep in the plan view is defined as “sEp”. The area of each intermediate electrolyte layer Ec in the plan view is defined as “sEc”. The area of each negative electrode side solid electrolyte layer in the plan view is defined as “sEn”. The area of each intermediate layer M in the plan view is defined as “sM”. The area of each negative electrode N in the plan view is defined as “sN”. Accordingly, “sN” is the area of a portion that includes the “negative electrode material layer Nm” and the “negative electrode current collector Nc” in the plan view. Note that, in the present embodiment, in the plan view, the area of the negative electrode current collector Nc is greater than or equal to the area of the negative electrode material layer Nm. Therefore, “sN” is substantially the area of the negative electrode current collector Nc in the plan view.

The solid-state battery Bt further includes a positive electrode tab Tp that protrudes from the positive electrode current collector Pc on the Y+ side. Accordingly, the “Y+ side” may be interpreted as the “direction of protrusion of the positive electrode tab Tp”. Note that the positive electrode P and the positive electrode tab Tp configure a positive electrode P-side electrical conductor. In addition, the solid-state battery Bt further includes a positive electrode tab insulator Ip that protrudes from the positive electrode frame F on the Y+ side. Note that the area of this positive electrode tab insulator Ip is not included in “sF”. In addition, the solid-state battery Bt further includes negative electrode tabs In that protrude from negative electrode current collectors Nc on the Y− side. Accordingly, the “Y− side” may be interpreted as the “direction of protrusion of the negative electrode tabs Tn”. Note that that the area of each negative electrode tab In is not included in “sN”. Each group of an intermediate layer M, a negative electrode N, and a negative electrode tab In configures a negative electrode N− side electrical conductor.

Next, details of each layer in the solid-state battery Bt are described in order from the positive electrode P side.

Aluminum foil or the like may be given as a concrete example of a material included in the positive electrode current collector Pc. The positive electrode tab Tp is integrally formed with the positive electrode current collector Pc.

The positive electrode material layer Pm includes a positive electrode active material that serves as material that is able to occlude and discharge lithium. A concrete example of the positive electrode active material may be LiCoO₂, Li(Ni_{5/10}CO_{2/10}Mn_{3/10})O₂, Li(Ni_{6/10}CO_{2/10}Mn_{2/10})O₂, Li(Ni_{8/10}CO_{1/10}Mn_{1/10})O₂, Li(Ni_{0.8}Co_{0.15}Al_{0.05})O₂, Li(Ni_{1/6}CO_{4/6}Mn_{1/6})O₂, Li(Ni_{1/3}CO_{1/3}Mn_{1/3})O₂, LiCoO₄, LiMn₂O₄, LiNiO₂, LifePO₄, lithium sulfide, sulfur, or the like. The positive electrode material layer Pm may also include a solid electrolyte, an electrically conductive aid, a binder, or the like. This positive electrode material layer Pm is positioned inside the positive electrode frame F. Therefore, “sPm” is the smallest from among “sPm”, “sE”, “sEp”, “sEc”, “sEn”, “sM”, and “sN”.

As illustrated in FIG. 1, the positive electrode frame F has a rectangular frame shape in plan view. A concrete example of a material included in the positive electrode frame F may be, inter alia, an insulating oxide such as alumina, a resin such as polyvinylidene fluoride (PVDF), or a rubber such as styrene-butadiene rubber (SBR). The positive electrode tab insulator Ip is integrally formed with the positive electrode frame F.

Each solid electrolyte layer E illustrated in FIG. 3 includes a solid electrolyte capable of conducting lithium ions. A concrete example of this solid electrolyte may be an oxide electrolyte, a sulfide electrolyte, or the like. In addition, each solid electrolyte layer E contains a binder.

Each positive electrode side electrolyte layer Ep is transferred onto the positive electrode frame F and the positive electrode material layer Pm, while employing a material including the positive electrode frame F and the positive electrode material layer Pm as a base. Therefore, the relationship “sF≥sEp” is satisfied. In addition, the positive electrode side electrolyte layer Ep is subsequently caused to be transferred to the intermediate electrolyte layer Ec. Therefore, the relationship “sEc≥sEp” is satisfied.

The intermediate electrolyte layer Ec is the main layer in the solid electrolyte layer E, and is thicker in the Z direction than each of the positive electrode side electrolyte layer Ep and the negative electrode side electrolyte layer En. The intermediate electrolyte layer Ec includes a porous base material such as non-woven fabric, and the previously described solid electrolyte that is filled in the base material. Binder content in the intermediate electrolyte layer Ec differs to binder content in the negative electrode side solid electrolyte layer. In the present embodiment, the intermediate electrolyte layer Ec satisfies the relationship “sEc>sF” in order to ensure the insulation distance between the positive electrode P-side electrical conductor and the negative electrode N-side electrical conductor.

The negative electrode side electrolyte layer En is transferred to the intermediate layer M, while employing a material including the intermediate layer M as a base. Therefore, the relationship “sM≥sEn” is satisfied. In addition, the negative electrode side electrolyte layer En is subsequently caused to be transferred to the intermediate electrolyte layer Ec. Therefore, the relationship “sEc≥sEn” is satisfied.

A concrete example of material included in the intermediate layer M may be, inter alia, carbon carrying metal (for example, silver, or the like) that can form an alloy with lithium. This intermediate layer M stabilizes the interface between the solid electrolyte layer E and the intermediate layer M, and the interface between the intermediate layer M and the negative electrode material layer Nm. Furthermore, this intermediate layer M has a function for causing lithium metal to precipitate uniformly. This intermediate layer M is transferred to the negative electrode material layer Nm, while employing a material including the negative electrode N as a base. Therefore, the relationship “sN≥sM” is satisfied. In addition, because “sN≥sM” in this manner, it becomes easier for the insulation distance between the intermediate layer M and the positive electrode P− side electrical conductor to be ensured.

The negative electrode material layer Nm includes a negative electrode active material that serves as material that is able to occlude and discharge lithium ions. A concrete example of this negative electrode active material may be metallic lithium, a lithium alloy, a metal oxide, a metal sulfide, a metal nitride, Si, SiO, carbon material, or the like. The carbon material may be artificial graphite, natural graphite, hard carbon, soft carbon, or the like, for example. The negative electrode material layer Nm may also include a solid electrolyte, an electrically conductive aid, a binder, or the like. Accordingly, the negative electrode material layer Nm, for example, may include metallic lithium as a principal component, or may include silicon as a principal component.

Copper foil or the like may be given as a concrete example of a material included in the negative electrode current collector Nc. The negative electrode tab In is integrally formed with the negative electrode current collector Nc. This negative electrode current collector Nc is formed in a range that satisfies the relationship “sF>sN”, from a perspective of insulation properties with respect to the positive electrode tab Tp.

Consequently, the relationship “sEc>sF≥sEp≥sN≥sM≥sEn≥sPm” is satisfied in the present embodiment. The relationship “sF>sN” is also satisfied in the present embodiment.

Next, with reference to the portion on the left in FIG.

3, description is given regarding the positional relationship between ends on the Y+ side for each layer in the solid-state battery Bt. Each of the negative electrode side electrolyte layer En, the intermediate layer M, the negative electrode material layer Nm, and the negative electrode current collector Nc protrudes on the Y+ side more than the positive electrode material layer Pm. Each of the positive electrode current collector Pc, the positive electrode frame F, the positive electrode side electrolyte layer Ep, and the intermediate electrolyte layer Ec protrudes on the Y+ side more than each of the layers En, M, Nm, and Nc. The positive electrode tab insulator Ip protrudes on the Y+ side more than each of the layers Pc, F, Ep, and Ec. The positive electrode tab Tp protrudes in the Y+ direction more than the positive electrode tab insulator Ip. Note that the length of protrusion by the positive electrode tab insulator Ip on the Y+ side with respect to the intermediate electrolyte layer Ec is approximately 0.3 to 1.0 mm.

Next, with reference to the portion on the right in FIG. 3, description is given regarding the positional relationship between ends on the Y− side for each layer in the solid-state battery Bt. Each of the negative electrode side electrolyte layer En, the intermediate layer M, the negative electrode material layer Nm, and the negative electrode current collector Nc protrudes on the Y− side more than the positive electrode material layer Pm. Each of the positive electrode current collector Pc, the positive electrode frame F, and the positive electrode side electrolyte layer Ep, protrudes on the Y− side more than each of the layers En, M, Nm, and Nc. The intermediate electrolyte layer Ec protrudes on the Y− side more than each of the layers Pc, F, and Ep. Note that the length of protrusion by the intermediate electrolyte layer Ec on the Y− side with respect to the positive electrode frame F is approximately 0.3 to 2.0 mm.

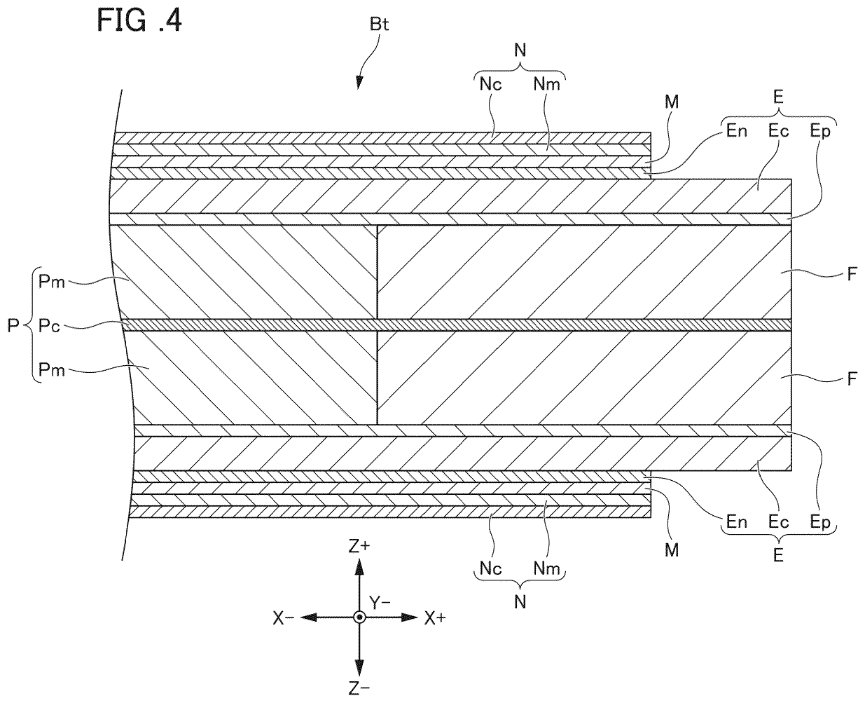

Next, with reference to FIG. 4, description is given regarding the positional relationship between edges in the X direction for each layer in the solid-state battery Bt. Note that FIG. 4 illustrates only edges on the X+ side for each layer in the solid-state battery Bt and does not illustrate edges on the X− side, but edges on the X− side are similar to a result of reversing the edges on the X+ side illustrated in FIG. 4 around the Z direction.

Each of the intermediate layer M, the negative electrode side electrolyte layer En, the negative electrode current collector Nc, and the negative electrode material layer Nm protrudes outward in the X direction more than the positive electrode material layer Pm. Each of the positive electrode current collector Pc, the positive electrode frame F, the positive electrode side electrolyte layer Ep, and the intermediate electrolyte layer Ec protrudes outward in the X direction more than each of the layers M, En, Nc, and Nm.

Next, description is given regarding a manufacturing method for the solid-state battery Bt describe above. This manufacturing method includes a positive electrode side manufacturing step, a negative electrode side manufacturing step, and an entire body manufacturing step. Of the positive electrode side manufacturing step and the negative electrode side manufacturing step, one may be performed before the other, or both may be performed in parallel. In contrast, the entire body manufacturing step is performed after the positive electrode side manufacturing step and the negative electrode side manufacturing step. Note that “transfer” referred to below is performed using a roll press or the like.

In the positive electrode manufacturing step, material that includes the positive electrode side electrolyte layer Ep is transferred to surfaces on both sides in the Z direction of material that includes the positive electrode current collector Pc, the positive electrode tab Tp, the positive electrode material layer Pm, and the positive electrode frame F.

In the negative electrode manufacturing step, firstly material that includes the intermediate layer M is transferred onto material that includes the negative electrode current collector Nc, the negative electrode tab In, and the negative electrode material layer Nm. Next, material that includes the negative electrode side electrolyte layer En is transferred onto material that includes the negative electrode current collector Nc, the negative electrode tab In, the negative electrode material layer Nm, and the intermediate layer M.

In the entire body manufacturing step, firstly, material that includes the intermediate electrolyte layer Ec is transferred onto surfaces on both sides in the Z direction of material manufactured in the positive electrode side manufacturing step. Next, onto both sides in the Z direction for the material resulting from this transferring, the material manufactured in the negative electrode side manufacturing step is also transferred. Next, the material resulting from transferring these materials is cut to thereby complete the internal structure of the solid-state battery Bt.

The internal structure of the solid-state battery Bt, which is manufactured in the above manner, is accommodated in a state of being pressed inside in the Z direction such that layers that are adjacent to each other in the Z direction are in close contact with each other. Therefore, in a state where the solid-state battery Bt is in use, the positive electrode P is always pressed toward the negative electrode N side, and each negative electrode N is always pressed toward the positive electrode P side.

The solid-state battery Bt, when in use, is repeatedly charged and discharged between a prescribed fully charged state and a prescribed fully discharged state. In conjunction with charging of the solid-state battery Bt, lithium is occluded by the negative electrode material layer Nm and the volume of the negative electrode N increases. In contrast, in conjunction with discharging, lithium is discharged from the negative electrode material layer Nm and the volume of the negative electrode N decreases.

A value resulting from dividing the volume of the negative electrode N in the fully charged state for the solid-state battery Bt by the volume of the negative electrode N in the fully discharged state is defined below as a “negative electrode expansion rate”. In the present embodiment, the negative electrode expansion rate is approximately greater than or equal to 2.5 times and less than or equal to 4.0 times. However, the negative electrode expansion rate may be changed, as appropriate, within a range such as greater than or equal to 1.8 times and less than or equal to 5.5 times, for example.

The configuration and effects of the present embodiment are summarized below.

The relationship “sEC>sF≥sEp≥sN≥sM≥sEn≥sPm” is satisfied in the present embodiment. Because “sF≥sEp”, transferring the positive electrode side electrolyte layer Ep to the positive electrode frame F and the positive electrode material layer Pm, while employing the material including the positive electrode frame F and the positive electrode material layer Pm as a base, is facilitated. In addition, because “sN≥sM”, transferring the intermediate layer M to the negative electrode N, while employing the material including the negative electrode N as a base, is facilitated. In addition, because “sM≥sEn”, transferring the negative electrode side electrolyte layer En to the intermediate layer M, while employing the material including the intermediate layer M as a base, is facilitated. In addition, because “sEc>sEp”, transferring the positive electrode side electrolyte layer Ep side to the intermediate electrolyte layer Ec is facilitated. In addition, because “sEc>sEn”, transferring the negative electrode side electrolyte layer En side to the intermediate electrolyte layer Ec is facilitated.

Because “sF>sEn”, the surface of the negative electrode side electrolyte layer En on the positive electrode frame F side is more likely to be flat. Furthermore, because “sF>sN”, the positive electrode frame F tends to expand to the portion which corresponds to edges of the negative electrode N. As a result, the positive electrode frame F can easily receive a load applied to an edge of the negative electrode N toward the positive electrode P side. Therefore, it becomes less likely for ill effects, such as this load being more likely to escape to the edge of the negative electrode N, to occur. Therefore, it becomes less likely for ill effects, such as a large amount of lithium being more likely to be occluded by edges of the negative electrode material layer Nm at a time of charging, to occur.

Moreover, because “sEc>sF”, edges of the intermediate electrolyte layer Ec protrude outward more than the edges of the positive electrode frame F. Therefore, the intermediate electrolyte layer Ec can ensure an insulation distance between the positive electrode P-side electrical conductor and the negative electrode N-side electrical conductor.

The intermediate electrolyte layer Ec protrudes toward the Y− side more than the positive electrode frame F. The intermediate electrolyte layer Ec can ensure the insulation distance between the negative electrode tab In and the positive electrode current collector Pc.

The intermediate electrolyte layer Ec is thicker in the Z direction than either of the positive electrode side electrolyte layer Ep and the negative electrode side electrolyte layer En. In this manner, the intermediate electrolyte layer Ec, which has the largest area and protrudes outwardly the farthest, is made to be thick in the Z direction, whereby it is possible to make the intermediate electrolyte layer Ec less susceptible to damage, even when subjected to a press load.

The intermediate electrolyte layer Ec includes a porous base material and a solid electrolyte that is filled into the base material. In this manner, by including the base material in the intermediate electrolyte layer Ec, it is possible to make the intermediate electrolyte layer Ec less susceptible to damage, even when subjected to a press load or the like.

Binder content in the intermediate electrolyte layer Ec differs to binder content in the negative electrode side electrolyte layer En. Therefore, it becomes easier to perform adjustment such that the strength of the intermediate electrolyte layer Ec is higher. As a result, it is possible to make the intermediate electrolyte layer Ec less susceptible to damage, even when subjected to a press load.

The positive electrode tab insulator Ip protrudes on the Y+ side more than the intermediate electrolyte layer Ec. The positive electrode frame F can ensure a greater insulation distance between the positive electrode tab Tp and the negative electrode N.

### Second Embodiment

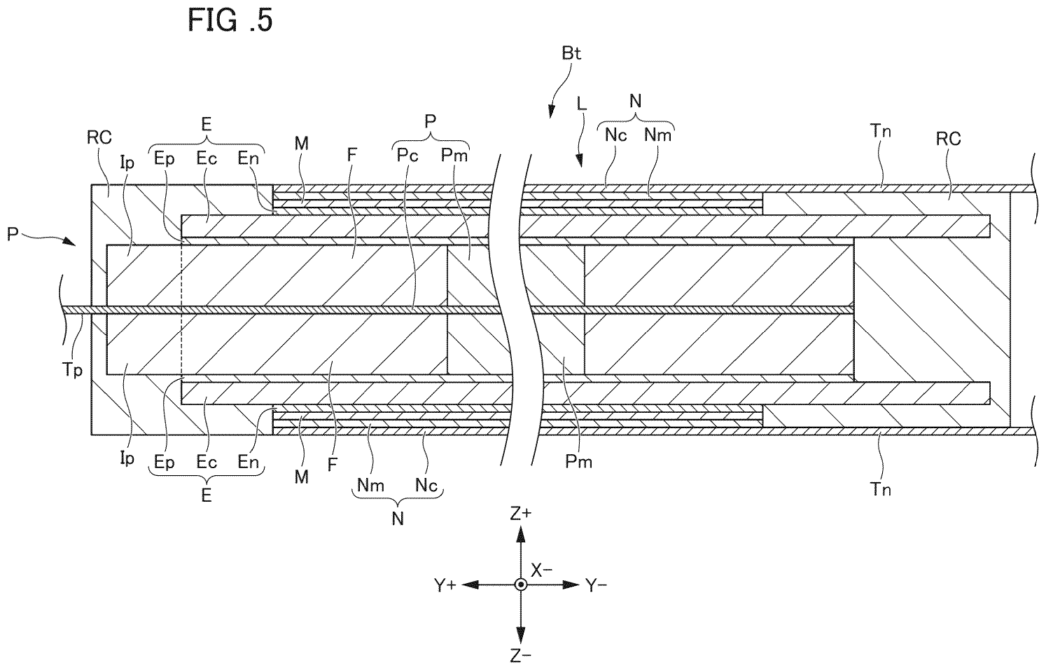

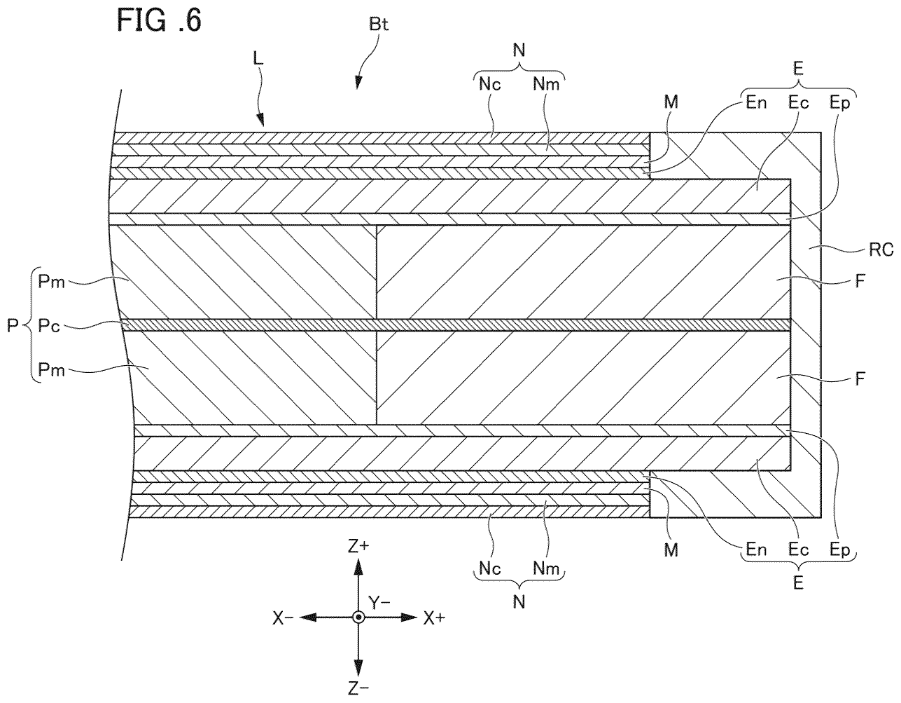

Next, with reference to FIG. 5 and FIG. 6, description is given regarding a second embodiment. The present embodiment is described based on the first embodiment, focusing on features different from those of the first embodiment, and description for features that are the same as or similar to those of the first embodiment is omitted as appropriate.

A major portion in the solid-state battery Bt is referred to below as a “multilayer body L”, as illustrated in FIG. 5. Specifically, the multilayer body L includes the positive electrode P and the positive electrode frame F, and includes the solid electrolyte layer E, the intermediate layer M, and the negative electrode N which are provided on both sides in the Z direction of the positive electrode P and the positive electrode frame F.

The solid-state battery Bt is also provided with a resin coating RC that covers edges in the X direction and the Y direction of this multilayer body L. Specifically, this resin coating RC covers, from the Y+ side, the edges of this multilayer body that are on the Y+ side, and also covers, from the Y− side, the edges of this multilayer body that are on the Y− side. In addition, as illustrated in FIG. 6, this resin coating RC covers, from the X+ side, the edges of this multilayer body that are on the X+ side and also covers, from the X− side, the edges of this multilayer body L that are on the X− side.

By virtue of the present embodiment, the resin coating RC can further improve insulation properties between the positive electrode P-side electrical conductor and the negative electrode N-side electrical conductor. Furthermore, similarly to the first embodiment, “sEc>sEn” as indicated in FIG. 5. Therefore, the resin coating RC can more easily enter into a region that is outside the edge of the negative electrode side electrolyte layer En and is between the intermediate electrolyte layer Ec and the negative electrode tab Tn.

### Other Embodiments

The embodiments described above can be modified as follows, for example. In the first embodiment, the positive electrode tab Tp and the negative electrode tabs In protrude in mutually opposite directions. Alternatively, the positive electrode tab Tp and the negative electrode tabs In may protrude in the same direction. Each positive electrode side electrolyte layer Ep does not need to be present in a case such as where it is possible to transfer the intermediate electrolyte layer Ec onto the positive electrode P even if the positive electrode side electrolyte layer Ep is not present.

The negative electrode N may be an anode-free electrode which lacks the negative electrode material layer Nm immediately after manufacture. In this case, a lithium metal layer as the negative electrode material layer Nm is formed after initial charging. In addition, the solid-state battery Bt may be a battery other than a lithium metal secondary battery. In this case, the intermediate layer M, which is for causing lithium metal to be uniformly precipitated, may be omitted.

In a case where it is possible to sufficiently ensure insulation properties between the positive electrode P and the negative electrodes N even if “sEc=sF”, it may be that “sEc=sF”.

### EXPLANATION OF REFERENCE NUMERALS

Bt Solid-state battery
Ec Intermediate electrolyte layer (prescribed solid electrolyte layer)
En Negative electrode side electrolyte layer (negative electrode side solid electrolyte layer)
Ep Positive electrode side electrolyte layer (positive electrode side solid electrolyte layer)
F Positive electrode frame
Ip Positive electrode tab insulator
M Intermediate layer
N Negative electrode
Nc Negative electrode current collector
Nm Negative electrode material layer
P Positive electrode
Pc Positive electrode current collector
Pm Positive electrode material layer
Tn Negative electrode tab
Tp Positive electrode tab
RC Resin coating

What is claimed is:

1. solid-state battery, comprising:
in an order going toward at least one way in a stacking direction, a positive electrode current collector, a positive electrode material layer, a prescribed solid electrolyte layer, a negative electrode side solid electrolyte layer, and a negative electrode, as well as a positive electrode tab that protrudes from the positive electrode current collector, and a negative electrode tab that protrudes from the negative electrode, wherein
a positive electrode frame, as an insulator, is provided closer to the negative electrode than the positive electrode current collector so as to surround a periphery of the positive electrode material layer,
a volume of the negative electrode increases in accordance with charging and the volume of the negative electrode decreases in accordance with discharging, and
defining an area inside of outer edges of the positive electrode frame in a plan view seen from the stacking direction as “sF”, defining an area of the prescribed solid electrolyte layer in the plan view as “sEc”, defining an area of the negative electrode side solid electrolyte layer in the plan view as “sEn”, and defining an area of the negative electrode in the plan view as “sN”,
a relationship “sEc≥sF>SN≥sEn” is satisfied.

2. The solid-state battery according to claim 1, further comprising
an intermediate layer between the negative electrode side solid electrolyte layer and the negative electrode, wherein
defining an area of the intermediate layer in the plan view as “sM”,
a relationship “sN≥sM≥sEn” is satisfied.

3. The solid-state battery according to claim 1, further comprising
a positive electrode side solid electrolyte layer between the positive electrode material layer and the prescribed solid electrolyte layer, wherein
defining an area of the positive electrode side solid electrolyte layer in the plan view as “sEp”,
a relationship “sEc≥sF≥sEp” is satisfied.

4. The solid-state battery according to claim 1, wherein
a relationship “sEc>sF” is satisfied.

5. The solid-state battery according to claim 1, wherein
the prescribed solid electrolyte layer protrudes, in a direction of protrusion of the negative electrode tab, more than the positive electrode frame.

6. The solid-state battery according to claim 1, wherein
the prescribed solid electrolyte layer is thicker in the stacking direction than the negative electrode side solid electrolyte layer.

7. The solid-state battery according to claim 1, wherein
the prescribed solid electrolyte layer includes a porous base material and a solid electrolyte that is filled in the base material.

8. The solid-state battery according to claim 1, wherein
the prescribed solid electrolyte layer contains a binder, and
a binder content in the prescribed solid electrolyte layer differs to a binder content in the negative electrode side solid electrolyte layer.

9. The solid-state battery according to claim 1, further comprising
a positive electrode tab insulator that protrudes from the positive electrode frame in a direction of protrusion of the positive electrode tab, wherein
the positive electrode tab insulator protrudes, in the direction of protrusion of the positive electrode tab, more than the prescribed solid electrolyte layer.

10. The solid-state battery according to claim 1, further comprising
a positive electrode side solid electrolyte layer between the positive electrode material layer and the prescribed solid electrolyte layer, and
an intermediate layer between the negative electrode side solid electrolyte layer and the negative electrode, wherein
defining an area of the positive electrode material layer Pm in the plan view as “sPm”,
defining an area of the positive electrode side solid electrolyte layer in the plan view as “sEp”, and
defining an area of the intermediate layer in the plan view as “sM”,
a relationship “sEc≥sF≥sEp≥sN≥sM≥sEn≥sPm” is satisfied.

11. The solid-state battery according to claim 1, further comprising:
a resin coating that covers ends in directions that are orthogonal to the stacking direction of a multilayer body that includes the positive electrode current collector, the positive electrode material layer, the positive electrode frame, the prescribed solid electrolyte layer, the negative electrode side solid electrolyte layer, and the negative electrode.

12. The solid-state battery according to claim 1, wherein
the negative electrode is provided with a negative electrode current collector, and a negative electrode material layer that is provided closer to the positive electrode current collector than the negative electrode current collector and includes metallic lithium.
